(19) United States
(12) Patent Application Publication
(10) Pub. No.: US 2019/0334765 A1
(43) Pub. Date: Oct. 31, 2019

(54) APPARATUSES AND METHODS FOR SITE CONFIGURATION MANAGEMENT

(71) Applicant: Nutanix, Inc., San Jose, CA (US)

(72) Inventors: AMIT JAIN, SAN JOSE, CA (US); JASPAL SINGH DHILLON, BENGALURU (IN); KARAN GUPTA, SAN JOSE, CA (US); PAVAN KUMAR KONKA, MILPITAS, CA (US)

(73) Assignee: Nutanix, Inc., San Jose, CA (US)

(21) Appl. No.: 15/967,324

(22) Filed: Apr. 30, 2018

(51) Int. Cl. H04L 12/24; G06F 8/65; G06F 17/30

(52) U.S. Cl. CPC H04L 41/082; G06F 17/30203; G06F 8/65

(57) ABSTRACT

Examples described herein may include management of a ROBO site. An example method includes detecting a first configuration of a first computing node cluster of a computing system over a first network, and detecting a second configuration of a second computing node cluster of the computing system over a second network. The example method further includes receiving a request to update a configuration of the computing system. The update includes an update of the first configuration of the first computing node cluster. The example method further includes determining whether the update of the first configuration of the first computing node cluster is compatible with the second configuration of the second computing node cluster, and in response to the update of the first configuration of the first computing node cluster being incompatible with the second configuration of the second computing node cluster, denying the request.

### TECHNICAL FIELD

Examples described herein relate generally to distributed computing systems. Examples of virtualized systems are described. Site configuration managers are provided in some examples of distributed computing systems described herein to management of site configuration modifications.

### BACKGROUND

A virtual machine (VM) generally refers to a software-based implementation of a machine in a virtualization environment, in which the hardware resources of a physical computer (e.g., CPU, memory, etc.) are virtualized or transformed into the underlying support for the fully functional virtual machine that can run its own operating system and applications on the underlying physical resources just like a real computer.

Virtualization generally works by inserting a thin layer of software directly on the computer hardware or on a host operating system. This layer of software contains a virtual machine monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a virtual machine may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine may not be utilized to perform useful work. This may be wasteful and inefficient if there are users on other physical machines which are currently waiting for computing resources. Virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

For operators with remote office, branch office (ROBO) server cluster sites, bringing new hardware installed at the ROBO sites may be difficult and/or expensive. Typically, hardware management of ROBO may involve temporarily or permanently deploying personnel tasked with managing the ROBO sites, but this set up may be inefficient and expensive.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a wide area computing system 100, in accordance with an embodiment of the present disclosure.

FIG. 2 is a block diagram of a distributed computing system, in accordance with an embodiment of the present disclosure.

FIG. 3 is a flow diagram illustrating a method for managing a site configuration in accordance with an embodiment of the present disclosure.

FIG. 4 depicts a block diagram of components of a computing node in accordance with an embodiment of the present disclosure.

### DETAILED DESCRIPTION

This disclosure describes embodiments for management hardware initialization at ROBO sites using a configuration server. When off-the-shelf hardware server nodes (nodes) are initially brought online, the node may be directed to a configuration server to manage installation and configuration of customer and/or application specific software images onto the new node. This initialization process has historically required IT personnel to be physically present to manage installation and configuration of the node. An ability to direct the node to a configuration server for installation and configuration of a node may reduce a need to deploy IT professionals to ROBO sites to manage installation and configuration of new nodes. In some examples, after powerup, the new node may automatically attempt to connect to a local area network (LAN) and obtain an internet, protocol (IP) address. After assignment of the IP address, the new node may attempt to connect to a configuration server. In some examples, the new node attempt to connect to the configuration server using a preset host name. In other examples, the host name may be provided during assignment of the IP address. The configuration server may use identifying information associated with the new node (e.g., media access control (MAC) address, serial number, model number, etc.) to determine an associated configuration, and may send software images and configuration information associated with the configuration.

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

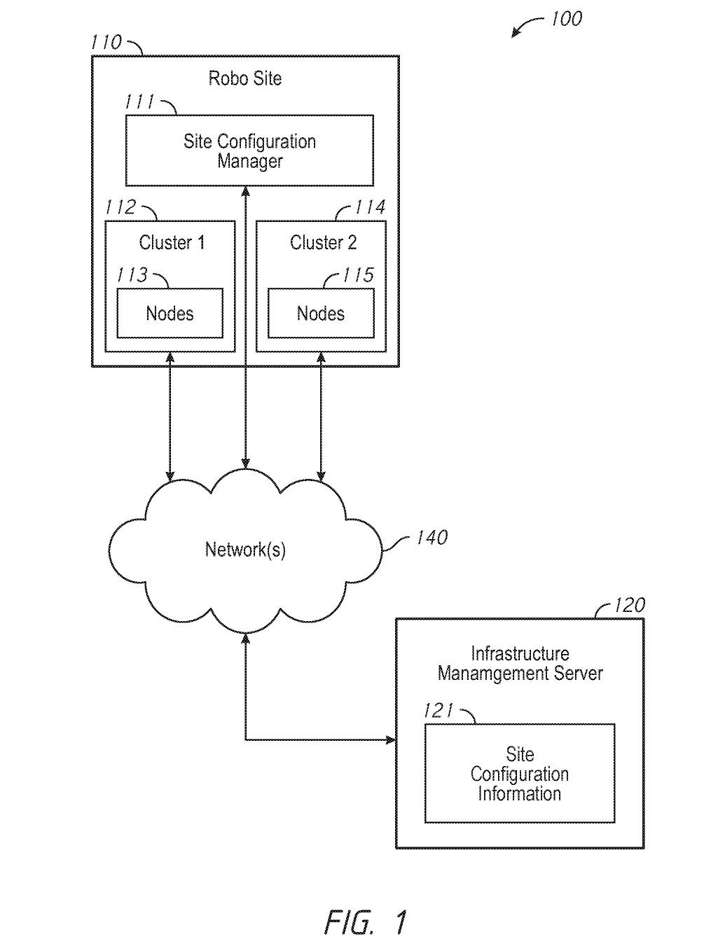

FIG. 1 is a block diagram of a wide area computing system 100, in accordance with an embodiment of the present disclosure. The wide area computing system of FIG. 1 generally includes a ROBO site 110 connected to an infrastructure management server 120 via a network 140. The network 140 may include any type of network capable of routing data transmissions from one network device (e.g., the ROBO site 110 and/or the infrastructure management server 120) to another. For example, the network 140 may include a local area network (LAN), wide area network (WAN), intranet, or a combination thereof. The network 140 may be a wired network, a wireless network, or a combination thereof.

The ROBO site 110 may include a computing node cluster 112 and a computing node cluster 114. More than two clusters may be included in the ROBO site 110 without departing from the scope of the disclosure. Each of the computing node cluster 112 and computing node cluster 114 may include respective computing nodes 113 and computing nodes 115. Each of the computing node cluster 112 and the computing node cluster 114 may perform specific functions. For example, the computing node cluster 112 may be a primary computing cluster used during normal operation, and the computing node cluster 114 may be a backup computing cluster that stores backup data in case the primary computing cluster fails. The provision of the computing node clusters 112 and 114, and their relationship may be established at the time of initial provisioning or installation. The site configuration manager 111 may be configured to automatically determine/detect the assigned roles/functions of the computing node clusters 112 and 114. The computing node cluster 112 and the computing node cluster 114 may be applied to other use cases, without departing from the scope of the disclosure. Because the computing node cluster 112 and the computing node cluster 114 may perform different functions, each of the computing node cluster 112 and the computing node cluster 114 include different hardware, software and firmware, and may have different support permissions, contracts, assigned policies, and update procedures. Further, operation of the computing node duster 112 and the computing node cluster 114 may rely on a level of compatibility between software builds to facilitate successful communication between the computing node cluster 112 and the computing node cluster 114, and within and among the computing nodes 113 of the computing node cluster 112 and within and among the computing nodes 115 of the computing node cluster 114. To manage these compatibility issues, and well as maintain other general configuration and health-related information, the site configuration manager 111 may manage software, firmware, and hardware configurations of the computing node cluster 112 and the computing node cluster 114, and may manage all other configuration information for the ROBO site 110.

The infrastructure management server 120 may communicate with the ROBO site 110 via the network 140. The infrastructure management server 120 operate configuration and/or infrastructure management software to manage configuration of the ROBO site 110. The infrastructure management server 120 may include site configuration information 121 that provides information for the ROBO site 110. From the perspective of the infrastructure management server 120, the ROBO site 110 may be managed as a single entity, rather than managing individual ones of the computing node cluster 112 and the computing node cluster 114 separately. That is, the computing node cluster 112 and the computing node cluster 114 may be transparent to the infrastructure management server 120 such that configuration of the ROBO site 110 managed by the site configuration manager 111. That is, the site configuration manager 111 may serve as an interface from the ROBO site 110 to the infrastructure management server 120 to manage configuration of the ROBO site 110. When the site configuration information 121 for any part of the ROBO site 110 is updated, the infrastructure management server 120 may send a request to the site configuration manager 111 to update the configuration of the ROBO site 110 based on the site configuration information 121. In response to acceptance of the request, the infrastructure management server 120 may send the updated site configuration information 121 to the site configuration manager 111. The site configuration information 121 may include software images, firmware, network configuration settings, policies, licenses, support contracts, marketing information, update procedures, any combination thereof, etc.

In operation, the ROBO site 110 may be in physically remote location from the infrastructure management server 120. Conventional management of the ROBO site 110 may be difficult and/or expensive, as options may include hiring personnel to be physically present to manage the ROBO site 110, or sending existing personnel to the ROBO site 110 to manage the ROBO site 110. To mitigate the conventional expense, the site configuration manager 111 and the infrastructure management server 120 may communicate to effectively manage the ROBO site 110. The site configuration manager 111 may keep track of all configuration information of the ROBO site 110. The configuration information may include hardware, software and firmware versions among the computing node cluster 112 and the computing node cluster 114, as well as specific support contracts, licenses, assigned policies, update procedures, marketing information, etc., for each of the computing node cluster 112 and the computing node cluster 114.

When the infrastructure management server 120 sends a request to update the configuration of the ROBO site 110 based on the site configuration information 121, the site configuration manager 111 may determine a current configuration to determine whether the updated configuration based on the site configuration information 121 is compatible with the current configuration. For example, the site configuration manager 111 may determine whether an updated policy of the site configuration information 121 is incompatible with one of the computing node cluster 112 or the computing node cluster 114. If the site configuration manager 111 detects an incompatibility, the site configuration manager 111 may reject or deny the request for the update. In another example, the site configuration information 121 may include a software or firmware update directed to the computing nodes 113 of the computing node cluster 112 that would make the computing node cluster 112 incompatible with the software or firmware version of the computing nodes 115 of the computing node cluster 114. The site configuration manager 111 may detect this incompatibility of deny the request to update. In yet another example, the site configuration information 121 may include a software or firmware update directed to the computing nodes 113 of the computing node cluster 112 that is incompatible with the hardware of the computing nodes 113. In some examples, an incompatibility determination may be driven by technology differences that make two pieces of software of hardware inoperable. In other examples, the incompatibility may be policy-driven, such as a desire to keep one of the computing node clusters 112 or 114 a version (e.g., or some other designation) behind the other. This may be desirable to ensure reliability of a new version of software in operation before upgrading an entire RORO site 110 to a new version. The site configuration manager 111 may detect this incompatibility of deny the request to update. If the site configuration manager 111 determines that the site configuration information 121 received from the infrastructure management server 120 is compatible with the ROBO site 110, the site configuration manager 111 may direct one or more of the computing nodes 113 of the computing node cluster 112, one or more of the computing nodes 115 of the computing node cluster 114, or combinations thereof, to schedule installation of the configuration update. The site configuration manager 111 may also manage scheduling of updates. In some examples, the site configuration manager 111 may operate on one of the computing nodes 113 or on one of the computing nodes 115.

If an upgrade involves repeated transfer of one or more large files (e.g., software image(s)) to one or more of the computing nodes 113 and/or to one or more of the computing nodes 115, the site configuration manager 111 may designate a master (e.g., or parent) node within the computing nodes 113 and/or the computing nodes 115 to receive and redistribute the large files to the slave (e.g., or child) nodes of the computing nodes 113 or the computing nodes 115, respectively. The use of master and slave nodes may leverage a high speed local-area network for the transfer in applications where the wide-area network reliability and/or bandwidth via the network 140 are limited from the infrastructure management server 120.

In addition, when the computing node cluster 112 and the computing node cluster 114 perform functions that rely on interaction between each other, the site configuration manager 111 may manage configuration mapping between the computing node cluster 112 and the computing node cluster 114, such as setting up virtual or physical networks for communication between the computing node cluster 112 and the computing node cluster 114, allocating addresses/host names/etc. that are used for the communication, etc.

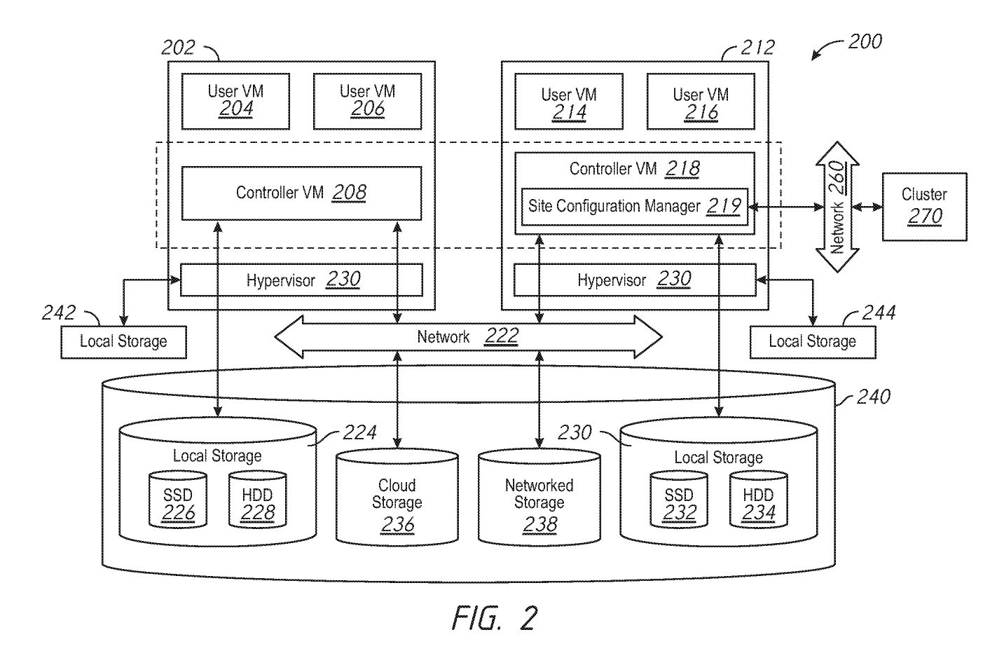

FIG. 2 is a block diagram of a distributed computing system 200, in accordance with an embodiment of the present disclosure. The distributed computing system of FIG. 2 generally includes computing node 202 and computing node 212 and storage 240 connected to a network 222. The network 222 may be any type of network capable of routing data transmissions from one network device (e.g., computing node 202, computing node 212, and storage 240) to another. For example, the network 222 may be a local area network (LAN), wide area network (WAN), intranet, Internet, or a combination thereof. The network 222 may be a wired network, a wireless network, or a combination thereof.

The storage 240 may include local storage 224, local storage 230, cloud storage 236, and networked storage 238. The local storage 224 may include, for example, one or more solid state drives (SSD 226) and one or more hard disk drives (HDD 228). Similarly, local storage 230 may include SSD 232 and HDD 234. Local storage 224 and local storage 230 may be directly coupled to, included in, and/or accessible by a respective computing node 202 and/or computing node 212 without communicating via the network 222. Cloud storage 236 may include one or more storage servers that may be stored remotely to the computing node 202 and/or computing node 212 and accessed via the network 222. The cloud storage 236 may generally include any type of storage device, such as HDDs SSDs, or optical drives. Networked storage 238 may include one or more storage devices coupled to and accessed via the network 222. The networked storage 238 may generally include any type of storage device, such as HDDs SSDs, or optical drives. In various embodiments, the networked storage 238 may be a storage area network (SAN).The computing node 202 is a computing device for hosting VMs in the distributed computing system of FIG. 2. The computing node 202 may be, for example, a server computer, a laptop computer, a desktop computer, a tablet computer, a smart phone, or any other type of computing device. The computing node 202 may include one or more physical computing components, such as processors.

The computing node 202 is configured to execute a hypervisor 210, a controller VM 208 and one or more user VMs, such as user VMs 204, 206. The user VMs including user VM 204 and user VM 206 are virtual machine instances executing on the computing node 202. The user VMs including user VM 204 and user VM 206 may share a virtualized pool of physical computing resources such as physical processors and storage (e.g., storage 240). The user VMs including user VM 204 and user VM 206 may each have their own operating system, such as Windows or Linux. While a certain number of user VMs are shown, generally any number may be implemented. User VMs may generally be provided to execute any number of applications which may be desired by a user.

The hypervisor 210 may be any type of hypervisor. For example, the hypervisor 210 may be ESX, ESX(i), Hyper-V, KVM, or any other type of hypervisor. The hypervisor 210 manages the allocation of physical resources (such as storage 240 and physical processors) to VMs (e.g., user VM 204, user VM 206, and controller VM 208) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 208 and/or controller VM 218, may provide services for the user VMs in the computing node. As an example of functionality that a controller VM may provide, the controller VM 208 may provide virtualization of the storage 240. Controller VMs may provide management of the distributed computing system shown in FIG. 2. Examples of controller VMs may execute a variety of software and/or may serve the I/O operations for the hypervisor and VMs running on that node. In some examples, a SCSI controller, which may manage SSD and/or HDD devices described herein, may be directly passed to the CVM, e.g., leveraging VM-Direct Path. In the case of Hyper-V, the storage devices may be passed through to the CVM.

The computing node 212 may include user VM 214, user VM 216, a controller VM 218, and a hypervisor 220. The user VM 214, user VM 216, the controller VM 218, and the hypervisor 220 may be implemented similarly to analogous components described above with respect to the computing node 202. For example, the user VM 214 and user VM 216 may be implemented as described above with respect to the user VM 204 and user VM 206. The controller VM 218 may be implemented as described above with respect to controller VM 208. The hypervisor 220 may be implemented as described above with respect to the hypervisor 210. In the embodiment of FIG. 2, the hypervisor 220 may be a different type of hypervisor than the hypervisor 210. For example, the hypervisor 220 may be Hyper-V, while the hypervisor 210 may be ESX(i).

The controller VM 208 and controller VM 218 may communicate with one another via the network 222. By linking the controller VM 208 and controller VM 218 together via the network 222, a distributed network of computing nodes including computing node 202 and computing node 212, can be created.

Controller VMs, such as controller VM 208 and controller VM 218, may each execute a variety of services and may coordinate, for example, through communication over network 222. Services running on controller VMs may utilize an amount of local memory to support their operations. For example, services running on controller VM 208 may utilize memory in local memory 242. Services running on controller VM 218 may utilize memory in local memory 244. The local memory 242 and local memory 244 may be shared by VMs on computing node 202 and computing node 212, respectively, and the use of local memory 242 and/or local memory 244 may be controlled by hypervisor 210 and hypervisor 220, respectively. Moreover, multiple instances of the same service may be running throughout the distributed system—e.g. a same services stack may be operating on each controller VM. For example, an instance of a service may be running on controller VM 208 and a second instance of the service may be running on controller VM 218.

Generally, controller VMs described herein, such as controller VM 208 and controller VM 218 may be employed to control and manage any type of storage device, including all those shown in storage 240 of FIG. 2, including local storage 224 (e.g., SSD 226 and HDD 228), cloud storage 236, and networked storage 238. Controller VMs described herein may implement storage controller logic and may virtualize all storage hardware as one global resource pool (e.g., storage 240) that may provide reliability, availability, and performance. IP-based requests are generally used (e.g., by user VMs described herein) to send I/O requests to the controller VMs. For example, user VM 204 and user VM 206 may send storage requests to controller VM 208 using an IP request. Controller VMs described herein, such as controller VM 208, may directly implement storage and I/O optimizations within the direct data access path.

In some examples, the controller VM 218 may include a site configuration manager 219 configured to manage information for a site (e.g., a logical or physical location). The site configuration manager 219 may communicate with the distributed computing system 200 via the network 222 and may communicate with the computing node cluster 270 via the network 260. The distributed computing system 200 and the computing node cluster 270 may perform different functions at the site, and may have different hardware, software, firmware, policy, permissions, etc. versions. The configuration information tracked and managed by the site configuration manager 219 may include hardware, software and firmware versions, as well as specific support contracts, licenses, assigned policies, update procedures, marketing information, etc., for each of the distributed computing system 200 and the computing node cluster 270. The site configuration manager 219 may receive a request to update the configuration of the site (e.g., the distributed computing system 200 and the computing node cluster 270) based on a site configuration image update. In response to the request, the site configuration manager 219 may determine a current configuration of the site to determine whether the updated configuration is compatible with the current configuration of the site. For example, the site configuration manager 219 may determine whether an updated policy is incompatible with one of the distributed computing system 200 or the computing node cluster 270. If the site configuration manager 219 detects an incompatibility, the site configuration manager 219 may reject or deny the request for the update. In another example, the requested update may include a software or firmware update directed to the distributed computing system 200 and/or the computing node cluster 270 that would make the distributed computing system 200 incompatible with the software or firmware version of the computing node cluster 270. The site configuration manager 219 may detect this incompatibility of deny the request to update. In yet another example, the requested update may include a software or firmware update directed to the nodes of distributed computing system 200 that are incompatible with the hardware of the computing node cluster 270. The site configuration manager 219 may detect this incompatibility of deny the request to update. If the site configuration manager 219 determines that the requested update is compatible with the site, the site configuration manager 219 may direct one or more of the computing nodes 202 and 212 of the distributed computing system 200, one or more of the computing nodes of the computing node cluster 270, or combinations thereof, to schedule installation of the requested update. The site configuration manager 219 may also manage scheduling of updates. If an upgrade involves repeated transfer of one or more large files (e.g., software image(s)) to one or more of the computing nodes 202 or 212 and/or to one or more of the computing nodes of the computing node cluster 270, the site configuration manager 219 may designate a master (e.g., or parent) node within the computing nodes 202 or 212 or the computing nodes of the computing node cluster 270 to receive and redistribute the large files to the slave (e.g., or child) nodes of the distributed computing system 200 or the computing node cluster 270, respectively. The use of master and slave nodes may leverage a high speed local-area network for the transfer in applications where the wide-area network reliability and/or bandwidth are limited. In addition, when the distributed computing system 200 and the computing node cluster 270 have functions that rely on interaction between each other, the site configuration manager 219 may manage configuration mapping between the distributed computing system 200 and the computing node cluster 270, such as setting up virtual or physical networks for communication between the distributed computing system 200 and the computing node cluster 270, allocating addresses/host names/etc. that are used for the communication, etc.

Note that the site configuration manager 219 may be run on another part of the computing node 212, such as the hypervisor 230 or one of the user VMs 212 or 214) or may run on the other computing node 202 without departing from the scope of the disclosure. Note that controller VMs are provided as virtual machines utilizing hypervisors described herein—for example, the controller VM 208 is provided behind hypervisor 210. Since the controller VMs run “above” the hypervisors examples described herein may be implemented within any virtual machine architecture, since the controller VMs may be used in conjunction with generally any hypervisor from any virtualization vendor.

Virtual disks (vDisks) may be structured from the storage devices in storage 240, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 208 may expose one or more vDisks of the storage 240 and may mount a vDisk on one or more user VMs, such as user VM 204 and/or user VM 206.

During operation, user VMs (e.g., user VM 204 and/or user VM 206) may provide storage input/output (I/O) requests to controller VMs (e.g., controller VM 208 and/or hypervisor 210). Accordingly, a user VM may provide an I/O request to a controller VM as an iSCSI and/or NFS request. Internet Small Computer System Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File System (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs.

During operation, user VMs described herein may provide storage requests using an IP based protocol. The storage requests may designate the IP address for a controller VM from which the user VM desires I/O services. The storage request may be provided from the user VM to a virtual switch within a hypervisor to be routed to the correct destination. For examples, the user VM 204 may provide a storage request to hypervisor 210. The storage request may request I/O services from controller VM 208 and/or controller VM 218. If the request is to be intended to be handled by a controller VM in a same service node as the user VM (e.g., controller VM 208 in the same computing node as user VM 204) then the storage request may be internally routed within computing node 202 to the controller VM 208, in some examples, the storage request may be directed to a controller VM on another computing node. Accordingly, the hypervisor (e.g., hypervisor 210) may provide the storage request to a physical switch to be sent over a network (e.g., network 222) to another computing node running the requested controller VM (e.g., computing node 212 running controller VM 218).

Accordingly, controller VMs described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

The site configuration manager 219 may be configured to manage information for the site at which the distributed computing system 200 and the computing node cluster 270 are located as single entity. That is, the site configuration manager 219 presents the site as a single entity in communication with an infrastructure management server. In some examples, the distributed computing system 200 and the computing node cluster 270 may perform different functions for the site, such as a primary or normal operation function and a backup function. The difference in functions may drive different software and hardware configurations. However, when the distributed computing system 200 and the computing node cluster 270 interact or share information, hardware and software compatibility may be integral to facilitating successful communication. The site configuration manager 219 maintains and manages detailed information for the site, including all hardware and software configurations to mitigate compatibility issues between the distributed computing system 200 and the computing node cluster 270. The site configuration manager 219 may retrieves configuration information for the distributed computing system 200 via the network 222 and retrieves configuration information for the computing node cluster 270 via the network 260. The configuration information tracked and managed by the site configuration manager 219 may include hardware, software and firmware versions, as well as specific support contracts, licenses, assigned policies, update procedures, marketing information, network configurations, etc., for each of the distributed computing system 200 and the computing node cluster 270. The site configuration manager 219 may receive a request to update the configuration of the site (e.g., the distributed computing system 200 and the computing node cluster 270) based on a site configuration image update. In response to the request, the site configuration manager 219 may determine a current configuration of the site to determine whether the updated configuration is compatible with the current configuration of the site. For example, the site configuration manager 219 may determine whether an updated policy/software or firmware image/permission/network configuration/etc. is incompatible with one of the distributed computing system 200 or the computing node cluster 270. If the site configuration manager 219 detects an incompatibility, the site configuration manager 219 may reject or deny the request for the update. If the site configuration manager 219 determines that the requested update is compatible with the site, the site configuration manager 219 may direct one or more of the computing nodes 202 and 212 of the distributed computing system 200, one or more of the computing nodes of the computing node cluster 270, or combinations thereof, to schedule installation of the requested update. The site configuration manager 219 may also manage scheduling of updates. If an upgrade involves repeated transfer of one or more large files (e.g., software image(s)) to one or more of the computing nodes 202 or 212 and/or to one or more of the computing nodes of the computing node cluster 270, the site configuration manager 219 may designate a master (e.g., or parent) node within the computing nodes 202 or 212 or the computing nodes of the computing node cluster 270 to receive and redistribute the large files to the slave (e.g., or child) nodes of the distributed computing system 200 or the computing node cluster 270, respectively. The use of master and slave nodes may leverage a high speed local-area network for the transfer in applications where the wide-area network reliability and/or bandwidth are limited. In addition, when the distributed computing system 200 and the computing node cluster 270 have functions that rely on interaction between each other, the site configuration manager 219 may manage configuration mapping between the distributed computing system 200 and the computing node cluster 270, such as setting up virtual or physical networks for communication between the distributed computing system 200 and the computing node cluster 270, allocating addresses/host names/etc. that are used for the communication, etc.

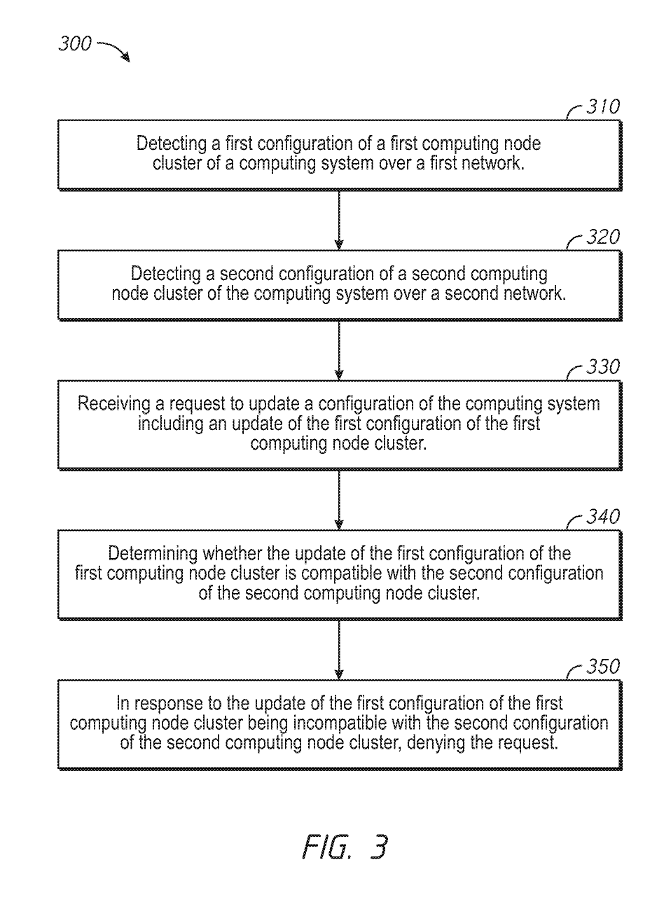

FIG. 3 is a flow diagram illustrating a method 300 for managing a site configuration in accordance with an embodiment of the present disclosure. The method 300 may be performed by the site configuration manager 111 of FIG. 1 or the site configuration manager 219 of FIG. 2.

The method 300 may include detecting a first configuration of a first computing node cluster of a computing system over a first network, at 310. The method 300 may further include detecting a second configuration of a second computing node cluster of the computing system over a second network, at 320. The first computing node cluster may include the computing node cluster 112 of FIG. 1 or the distributed computing system 200 of FIG. 2. The second computing node cluster may include the computing node cluster 114 of FIG. 1 or the computing node cluster 270 of FIG. 2. In some examples, the first network and the second network may include virtual networks. In some examples, the first computing node cluster may be co-located with the second computing node cluster. The first computing node cluster may include a first plurality of computing nodes and wherein the second computing node cluster may include a second plurality of computing nodes. In some examples, the first computing node cluster is a primary computing node cluster and wherein the second computing node cluster is a backup computing node cluster.

The method 300 may further include receiving a request to update a configuration of the computing system, at 330. The update may include an update of the first configuration of the first computing node cluster. In some examples, the request may be received from an infrastructure management server via a wide area network (e.g., from the infrastructure management server 120 of FIG. 1). Detection of the first configuration of the first computing node cluster (e.g., or the second configuration of the second computing node cluster) may include detecting a software and firmware configuration of the first computing node cluster (e.g., or the second configuration of the second computing node cluster), in some examples. Detection of the first configuration of the first computing node cluster (e.g., or the second configuration of the second computing node cluster) may include detecting a network configuration of the first computing node cluster (e.g., or the second configuration of the second computing node cluster), in some examples. Detection of the first configuration of the first computing node cluster (e.g., or the second configuration of the second computing node cluster) may include detecting any of support permissions, contracts, assigned policies, or update procedures of the first computing node cluster (e.g., or the second configuration of the second computing node cluster), in some examples.

The method 300 may further include determining whether the update of the first configuration of the first computing node cluster is compatible with the second configuration of the second computing node cluster, at 340.

The method 300 may further include, in response to the update of the first configuration of the first computing node cluster being incompatible with the second configuration of the second computing node cluster, denying the request, at 350. In some examples, the method 300 may further include, in response to the update of the first configuration of the first computing node cluster being compatible with the second first configuration of the second computing node cluster, granting the request. In some examples, the method 300 may further include detecting a hardware version of the first computing node cluster over the first network, and determining whether the update of the first configuration of the first computing node cluster is compatible with the hardware version of the first computing node cluster. In response to the update of the first configuration of the first computing node cluster being incompatible with the hardware version of the first computing node cluster, the method 300 may further include denying the request.

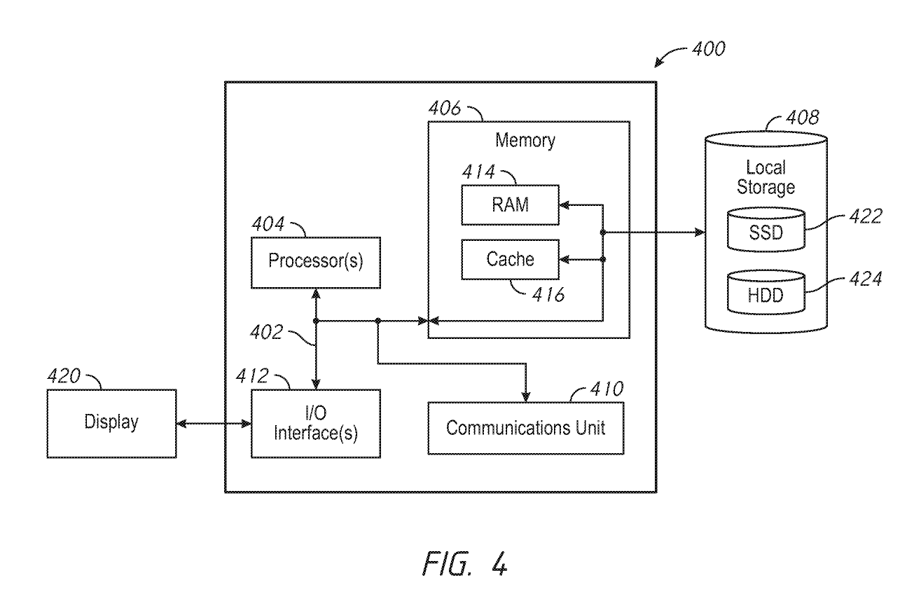

FIG. 4 depicts a block diagram of components of a computing node 400 in accordance with an embodiment of the present disclosure. It should be appreciated that FIG. 4 provides only an illustration of one implementation and does not imply any limitations with regard to the environments in which different embodiments may be implemented. Many modifications to the depicted environment may be made. The computing node 400 may implemented as the computing node 102 and/or computing node computing node cluster 112. The computing node 400 may be configured to implement the method described with reference to FIGS. 2A-2H, in some examples, to migrate data associated with a service running on any VM.

The computing node 400 includes a communications fabric 402, which provides communications between one or more processor(s) 404, memory 406, local storage 408, communications unit 410, I/O interface(s) 412. The communications fabric 402 can be implemented with any architecture designed for passing data and/or control information between processors (such as microprocessors, communications and network processors, etc.), system memory, peripheral devices, and any other hardware components within a system. For example, the communications fabric 402 can be implemented with one or more buses.

The memory 406 and the local storage 408 are computer-readable storage media. In this embodiment, the memory 406 includes random access memory RAM 414 and cache 416. In general, the memory 406 can include any suitable volatile or non-volatile computer-readable storage media. The local storage 408 may be implemented as described above with respect to local storage 224 and/or local storage 240. In this embodiment, the local storage 408 includes an SSD 422 and an HDD 424, which may be implemented as described above with respect to SSD 126, SSD 132 and HDD 128, HDD 134 respectively.

Various computer instructions, programs, files, images, etc. may be stored in local storage 408 for execution by one or more of the respective processor(s) 404 via one or more memories of memory 406. In some examples, local storage 408 includes a magnetic HDD 424. Alternatively, or in addition to a magnetic hard disk drive, local storage 408 can include the SSD 422, a semiconductor storage device, a read-only memory (ROM), an erasable programmable read-only memory (EPROM), a flash memory, or any other computer-readable storage media that is capable of storing program instructions or digital information.

The media used by local storage 408 may also be removable. For example, a removable hard drive may be used for local storage 408. Other examples include optical and magnetic disks, thumb drives, and smart cards that are inserted into a drive for transfer onto another computer-readable storage medium that is also part of local storage 408.

Communications unit 410, in these examples, provides for communications with other data processing systems or devices. In these examples, communications unit 410 includes one or more network interface cards. Communications unit 410 may provide communications through the use of either or both physical and wireless communications links.

I/O interface(s) 412 allows for input and output of data with other devices that may be connected to computing node 400. For example, I/O interface(s) 412 may provide a connection to external device(s) 418 such as a keyboard, a keypad, a touch screen, and/or some other suitable input device. External device(s) 418 can also include portable computer-readable storage media. such as, for example, thumb drives, portable optical or magnetic disks, and memory cards. Software and data used to practice embodiments of the present disclosure can be stored on such portable computer-readable storage media and can be loaded onto local storage 408 via I/O interfaces) 412. I/O interface(s) 412 also connect to a display 420.

Display 420 provides a mechanism to display data to a user and may be, for example, a computer monitor.

What is claimed is:

1. A method comprising:
detecting a first configuration of a first computing node cluster of a computing system over a first network;
detecting a second configuration of a second computing node cluster of the computing system over a second network;
receiving a request to update a configuration of the computing system, wherein the update includes an update of the first configuration of the first computing node cluster;
determining whether the update of the first configuration of the first computing node cluster is compatible with the second configuration of the second computing node cluster;
in response to the update of the first configuration of the first computing node cluster being incompatible with the second configuration of the second computing node cluster, denying the request.

2. The method of claim 1, further comprising, in response to the update of the first configuration of the first computing node cluster being compatible with the second first configuration of the second computing node cluster, granting the request.

3. The method of claim 1, wherein detecting the first configuration of the first computing node cluster comprises detecting a software and firmware configuration of the first computing node cluster.

4. The method of claim 3, wherein detecting the first configuration of the first computing node cluster further comprises detecting a network configuration of the first computing node cluster.

5. The method of claim 3, wherein detecting the first configuration of the first computing node cluster further comprises detecting any of support permissions, contracts, assigned policies, or update procedures of the first computing node cluster.

6. The method of claim 1, further comprising:
detecting a hardware version of the first computing node cluster over the first network;
determining whether the update of the first configuration of the first computing node cluster is compatible with the hardware version of the first computing node cluster;
in response to the update of the first configuration of the first computing node cluster being incompatible with the hardware version of the first computing node cluster, denying the request.

7. The method of claim 1, wherein the first network and the second network are virtual networks.

8. The method of claim 1, wherein the request is received from an infrastructure management server via a wide area network.

9. The method of claim 1, wherein the first computing node cluster is co-located with the second computing node cluster.

10. The method of claim 1, wherein the first computing node cluster comprises a first plurality of computing nodes and wherein the second computing node cluster comprises a second plurality of computing nodes.

11. The method of claim 1, wherein the first computing node cluster is a primary computing node cluster and wherein the second computing node cluster is a backup computing node cluster.

12. At least one non-transitory computer-readable storage medium including instructions that when executed by a computing node in a computing system, cause the computing node to:
receive a request to update firmware and software of the computing system, wherein the update includes an update of a first firmware and software version of a first computing node cluster of the computing system and an update of a second firmware and software version of a second computing node cluster of the computing system;
detect a current version of the first firmware and software version of the first computing node cluster via a first virtual network;
detect a current version of the second firmware and software version of the second computing node cluster via a second virtual network;
determine whether the update of the first firmware and software of the first computing node cluster is compatible with the current version of the first firmware and software version of the first computing node cluster and compatible with the updated version of the second firmware and software version of the second computing node cluster;
in response to the update of the first firmware and software of the first computing node cluster being incompatible with either the current version of the first firmware and software version of the first computing node cluster or the update of the second firmware and software version of the second computing node cluster, deny the request.

13. The at least one computer-readable storage medium of claim 8, wherein the instructions that when executed by a computing node in a computing system, further cause the computing node to schedule installation of the firmware and software update of the computing system in response to the update of the first firmware and software of the first computing node cluster being compatible with both of the current version of the first firmware and software version of the first computing node cluster and the update of the second firmware and software version of the second computing node cluster.

14. The at least one computer-readable storage medium of claim 10, wherein the instructions that when executed by the computing node in a computing system, further cause the computing node to instruct a first computing node of the first computing node cluster to manage installation of the update of the first firmware and software of the first computing node cluster.

15. The at least one computer-readable storage medium of claim 11, wherein the instructions that when executed by the computing node in a computing system, further cause the computing node to instruct a second computing node of the second computing node cluster to manage installation of the update of the second firmware and software of the second computing node cluster.

16. The at least one computer-readable storage medium of claim 9, wherein the firmware and software update of the computing system comprises at least one of an update to a hypervisor or an operating system of the first computing node cluster.

17. The at least one computer-readable storage medium of claim 9, wherein the firmware and software update of the computing system comprises at least one of an update to a hypervisor or an operating system of the first computing node cluster.

18. A system comprising:
a site comprising:
a first computing node cluster having a first configuration;
a second computing node cluster having a second configuration;
and a site configuration manager configured to detect the first configuration of the first computing node cluster via a first network and detect the second configuration of the second computing node cluster via a second network, wherein the site configuration manage is further configured to receive a request to update a configuration of the computing system, wherein the update includes an update of the first configuration of the first computing node cluster, the site configuration manager further configured to determine whether the update of the first configuration of the first computing node cluster is compatible with the second configuration of the second computing node cluster, and in response to the update of the first configuration of the first computing node cluster being incompatible with the second configuration of the second computing node cluster, denying the request.

19. The system of claim 18, wherein the request is received from an infrastructure management server via a wide area network.

20. The method of claim 1, wherein the first computing node cluster comprises a first plurality of computing nodes configured as a distributed file server system and wherein the second computing node cluster comprises a second plurality of computing nodes configured as a backup file system.
